(19) United States
(12) Patent Application Publication
(10) Pub. No.: US 2026/0301392 A1
(43) Pub. Date: Oct. 1, 2026

(54) TRAINING APPARATUS AND METHOD FOR MACHINE LEARNING MODEL, AND ESTIMATION APPARATUS FOR THREE-DIMENSIONAL POSE

(71) Applicants: Beijing BOE Technology Development Co., Ltd., Beijing (CN); BOE Technology Group Co., Ltd., Beijing (CN)

(72) Inventors: Ziyue ZHANG, Beijing (CN); Yu GU, Beijing (CN)

(21) Appl. No.: 19/490,981

(22) PCT Filed: May 15, 2024
(86) PCT No.: PCT/CN2024/093322

§ 371 Date: Dec. 8, 2025

(30) Foreign Application Priority Data
Jun. 12, 2023 (CN) 202310691946.6

(51) Int. Cl. G06V 10/778; G06T 7/73

(52) U.S. Cl. CPC G06V 10/778; G06T 7/73

(57) ABSTRACT

A training apparatus for a machine learning model includes at least one processor configured to: acquire a plurality of two-dimensional images and a machine learning model to be trained, where the plurality of two-dimensional images include a target, and the machine learning model includes first and second three-dimensional pose estimation modules; based on any one of the two-dimensional images, use the first three-dimensional pose estimation module to estimate a first three-dimensional pose of the target; based on at least two of the two-dimensional images, use the second three-dimensional pose estimation module to estimate a second three-dimensional pose of the target, where the at least two of the two-dimensional images have different viewing angles from each other; and train, based on a difference between the first and second three-dimensional poses, at least one of the first three-dimensional pose estimation module or the second three-dimensional pose estimation module.

### CROSS-REFERENCE TO RELATED APPLICATIONS

The present application is based on and claims priority from CN application No. 202310691946.6, filed on Jun. 12, 2023, the disclosure of which is hereby incorporated by reference in its entirety.

### TECHNICAL FIELD

The present disclosure relates to the technical field of computers, and particularly relates to a training apparatus for a machine learning model, a training method for a machine learning model, an estimation apparatus for a three-dimensional pose, an estimation method for a three-dimensional pose, an electronic device, and a non-volatile computer-readable storage medium.

### BACKGROUND

The estimation method for a three-dimensional human pose under the monocular viewing angle is widely concerned in the field of computer vision, and a plurality of related applications are derived. For example, by estimating three-dimensional human poses through machine learning, various applications can be derived, including human-machine interaction, motion recognition, virtual reality, and the like.

In the existing art, with the great success of the deep learning model and the increasingly complex data sets, a deep convolutional neural network (CNN) may be applied in estimation of three-dimensional human poses in a monocular camera context.

### SUMMARY

According to some embodiments of the present disclosure, there is provided a training apparatus for a machine learning model, including at least one processor configured to: acquire a plurality of two-dimensional images and a machine learning model to be trained, wherein the plurality of two-dimensional images include a target, and the machine learning model includes a first three-dimensional pose estimation module and a second three-dimensional pose estimation module; based on any one of the two-dimensional images, use the first three-dimensional pose estimation module to estimate a first three-dimensional pose of the target; based on at least two of the two-dimensional images, use the second three-dimensional pose estimation module to estimate a second three-dimensional pose of the target, wherein the at least two of the two-dimensional images have different viewing angles from each other; and train, based on a difference between the first three-dimensional pose and the second three-dimensional pose, at least one of the first three-dimensional pose estimation module or the second three-dimensional pose estimation module.

In some embodiments, the target includes a plurality of feature points, and based on at least two of the two-dimensional images, using the second three-dimensional pose estimation module to estimate the second three-dimensional pose of the target includes: estimating, based on the at least two of the two-dimensional images, information of a three-dimensional space range in which each of the plurality of feature points of the target is located; and estimating the second three-dimensional pose according to the information of the three-dimensional space range.

In some embodiments, estimating, based on the at least two of the two-dimensional images, information of the three-dimensional space range in which each of the plurality of feature points of the target is located includes: estimating a two-dimensional feature point heat map of each of the at least two-dimensional images; and estimating the information of the three-dimensional space range according to the two-dimensional feature point heat map.

In some embodiments, estimating the second three-dimensional pose according to the information of the three-dimensional space range includes: estimating a three-dimensional feature point heat map according to the information of the three-dimensional space range; and estimating the second three-dimensional pose according to the three-dimensional feature point heat map.

In some embodiments, estimating the second three-dimensional pose according to the three-dimensional feature point heat map includes: estimating the second three-dimensional pose by performing soft-argmax processing on the three-dimensional feature point heat map.

In some embodiments, the three-dimensional space range includes a cubic space range.

In some embodiments, estimating, based on the at least two of the two-dimensional images, information of the three-dimensional space range in which each of the plurality of feature points of the target is located includes: using a 3D pictorial structures (3DPS) module to estimate the information of the three-dimensional space range.

In some embodiments, training, based on the difference between the first three-dimensional pose and the second three-dimensional pose, at least one of the first three-dimensional pose estimation module or the second three-dimensional pose estimation module includes: acquiring a first key point of the first three-dimensional pose and a second key point of the second three-dimensional pose; correcting, based on the first key point and the second key point, the second three-dimensional pose and the first three-dimensional pose to a same viewing angle; and training, based on a difference between the corrected first three-dimensional pose and second three-dimensional pose, at least one of the first three-dimensional pose estimation module or the second three-dimensional pose estimation module.

In some embodiments, correcting, based on the first key point and the second key point, the second three-dimensional pose and the first three-dimensional pose to the same viewing angle includes: correcting the second three-dimensional pose to a viewing angle of the first three-dimensional pose to generate a third three-dimensional pose, such that at least one of the first three-dimensional pose estimation module or the second three-dimensional pose estimation module is trained based on a difference between the third three-dimensional pose and the first three-dimensional pose.

In some embodiments, acquiring the first key point of the first three-dimensional pose and the second key point of the second three-dimensional pose includes: using a first lifting network module to estimate the first key point and the second key point.

In some embodiments, the first key point is at a center position of the first three-dimensional pose, and the second key point is at a center position of the second three-dimensional pose.

In some embodiments, based on any one of the two-dimensional images, using the first three-dimensional pose estimation module to estimate the first three-dimensional pose of the target includes: based on any one of the two-dimensional images, using a first two-dimensional detection module to estimate a two-dimensional pose of the target; and according to the two-dimensional pose of the target, using a second lifting network module to estimate the first three-dimensional pose.

In some embodiments, based on any one of the first two-dimensional images, using the first two-dimensional detection module to estimate the two-dimensional pose of the target includes: estimating, based on any one of the first two-dimensional images, a two-dimensional feature point heat map of the first two-dimensional image; and estimating the two-dimensional pose according to the two-dimensional feature point heat map.

In some embodiments, estimating the two-dimensional pose according to the two-dimensional feature point heat map includes: estimating the two-dimensional pose by performing soft-argmax processing on the two-dimensional feature point heat map.

In some embodiments, the second lifting network module includes a batch normalization layer, a dropout layer, a rectified linear layer, and a residual connection layer.

In some embodiments, training, based on the difference between the first three-dimensional pose and the second three-dimensional pose, at least one of the first three-dimensional pose estimation module or the second three-dimensional pose estimation module includes: determining a mean square error (MSE) loss and a two-dimensional reprojection loss based on the difference between the first three-dimensional pose and the second three-dimensional pose; and training, according to a weighted average of the MSE loss and the two-dimensional reprojection loss, at least one of the first three-dimensional pose estimation module or the second three-dimensional pose estimation module until a training end condition is met.

In some embodiments, the target includes a human target, and the plurality of feature points of the human target includes a plurality of joint points.

In some embodiments, the training apparatus further includes: a display device configured to display at least one of the first three-dimensional pose or the second three-dimensional pose.

According to some other embodiments of the present disclosure, there is provided an estimation apparatus for a three-dimensional pose, including: the training apparatus for a machine learning model according to any of the above embodiments, which is configured to train a first three-dimensional pose estimation module of a machine learning model; and at least one processor configured to: acquire a two-dimensional image containing a target; and based on the two-dimensional image, use the trained first three-dimensional pose estimation module to estimate a three-dimensional pose of the target.

In some embodiments, the processor is configured to: acquire a usage requirement of the machine learning model; and convert the machine learning model to a format matched with the usage requirement.

In some embodiments, the processor is configured to: in response to a setting operation of a user, set a deployment environment and model parameters of the machine learning model.

In some embodiments, the display device is configured to display the three-dimensional pose.

According to still other embodiments of the present disclosure, there is provided a training method for a machine learning model, including: based on any two-dimensional image containing a target, using a first three-dimensional pose estimation module of a machine learning model to estimate a first three-dimensional pose of the target; based on at least two two-dimensional images containing the target, using a second three-dimensional pose estimation module of a machine learning model to estimate a second three-dimensional pose of the target, wherein the plurality of second two-dimensional images have different viewing angles from each other; and training, based on a difference between the first three-dimensional pose and the second three-dimensional pose, at least one of the first three-dimensional pose estimation module or the second three-dimensional pose estimation module.

According to still other embodiments of the present disclosure, there is provided an estimation method for a three-dimensional pose, including: training a first three-dimensional pose estimation module of a machine learning model in the training method for a machine learning model according to any of the above embodiments; and based on a two-dimensional image containing a target, using the first three-dimensional pose estimation module to estimate a three-dimensional pose of the target.

According to still other embodiments of the present disclosure, there is provided an electronic device, including: a memory; and a processor coupled to the memory and configured to perform the training method for a machine learning model or the estimation method for a three-dimensional pose according to any of the above embodiments based on instructions stored in the memory device.

According to still other embodiments of the present disclosure, there is provided a non-volatile computer-readable storage medium having a computer program stored thereon which, when executed by a processor, causes the training method for a machine learning model or the estimation method for a three-dimensional pose according to any of the above embodiments to be implemented.

Other features of the present disclosure and advantages thereof will become apparent from the following detailed description of exemplary embodiments of the present disclosure with reference to the accompanying drawings.

### BRIEF DESCRIPTION OF DRAWINGS

The drawings described herein are intended to provide a further understanding of the present disclosure, and are intended to be a part of the present application. The exemplary embodiments of the present disclosure and the description thereof are for explaining the present disclosure and do not constitute any undue limitation to the present disclosure. In the drawings:

FIG. 1 shows a flowchart of a training method for a machine learning model according to some embodiments of the present disclosure;

FIG. 2 shows a schematic diagram of a training method for a machine learning model according to some other embodiments of the present disclosure;

FIG. 3 shows a schematic diagram of a training method for a machine learning model according to some embodiments of the present disclosure;

FIG. 4 shows a schematic diagram of an estimation method for a three-dimensional pose according to some embodiments of the present disclosure;

FIGS. 5a to 5e show schematic diagrams of a machine learning model development and deployment platform according to some embodiments of the present disclosure;

FIG. 6a shows a block diagram of a training apparatus for a machine learning model according to some embodiments of the present disclosure;

FIG. 6b shows a block diagram of an estimation apparatus for a three-dimensional pose according to some embodiments of the present disclosure;

FIG. 7 shows a block diagram of some embodiments of an electronic device according to the present disclosure; and

FIG. 8 shows a block diagram of some other embodiments of an electronic device according to the present disclosure.

### DETAIL DESCRIPTION OF EMBODIMENTS

The technical solutions in the embodiments of the present disclosure will be clearly and completely described below with reference to the accompanying drawings in the embodiments of the present disclosure. Obviously, the described embodiments are merely some, not all, of the embodiments of the present disclosure. The following description of at least one exemplary embodiment is merely illustrative in nature and is in no way intended to limit the present disclosure or applications or uses thereof. All other embodiments obtained by the ordinarily skilled in the art based on the embodiments of the present disclosure without paying any creative effort shall be included in the protection scope of the present disclosure.

The relative arrangement of parts and steps, numerical expressions and numerical values set forth in the embodiments do not limit the scope of the present disclosure, unless specifically stated otherwise. Meanwhile, it should be understood that the sizes of the respective portions shown in the drawings are not drawn in an actual proportional relation for the convenience of description. Techniques, methods, and apparatuses known to one of ordinary skill in the existing art may not be discussed in detail but are intended to be part of the specification where appropriate. In all examples shown and discussed herein, any specific value should be construed as exemplary only and not as limiting. Thus, other examples of the exemplary embodiments may have different values. It should be noted that: like reference numbers and letters refer to like items in the following figures, and thus, once an item is defined in one figure, it need not be discussed further in subsequent figures.

The previously discussed method of estimating three-dimensional poses using a neural network from the viewing angle of a monocular camera faces some challenges.

First, the training of most typical neural network models requires a large amount of annotated data about three-dimensional human poses. These methods rely on annotated three-dimensional skeletons as three-dimensional pose annotations, which are collected by a label-based motion capture system, for depth prediction. However, the label-based motion capture system is costly, which means that annotating three-dimensional (3D) poses as ground truth by a label-based motion capture system is a costly process.

Second, the mathematical theory regarding the projection of two-dimensional (2D) joints into 3D space has been well documented, and the neural network itself is an approximation of such projections. Therefore, over-relying on 3D real data may lead to over-fitting problems.

Again, the method of training at a monocular camera viewing angle may lead to depth blurring problems. Since multiple different 3D skeletons may be projected into the same 2D pose in a particular camera viewing angle, estimating a 3D pose from a monocular viewing angle may result in a strange 3D pose.

In view of the above technical problems, the present disclosure proposes a self-supervised model. Instead of annotated training data, the model only need unlabeled multi-view data. For example, the present disclosure can train a network based on geometric knowledge without labeled 3D poses.

For example, the present disclosure constructs a pipeline that follows two steps: a 2D skeleton estimator in multiple camera viewing angles, and a 2D to 3D pose lifting network capable of outputting an estimated 3D pose. The skeletal estimator may estimate two-dimensional coordinates or a two-dimensional heat map of feature points forming a skeletal model of a target.

For example, the present disclosure further adopts multi-view consistency constraints to better converge the captured 2D poses to 3D poses. For incomplete or erroneous 2D detection, the multi-view setting also solves the technical problem of depth blurring.

For example, the present disclosure uses confidence of 2D joints to integrate losses from different viewing angles to mitigate the effects of noise caused by self-occlusion.

In view of the above technical problems, the present disclosure proposes a self-supervised training method in a multi-view training setting. By using a self-supervised approach instead of explicit 3D real labeling, the training can be completed with only 2D pose estimation generated by the 2D pose estimator as the input.

In this manner, the depth blurring problem can be overcome through the multi-view setting, and the incomplete or erroneous 2D detection can be solved by utilizing information from other viewing angles.

For example, the multi-view setting is more advantageous in model training because information from different viewing angles and the monocular setting have a wider range of application scenarios. The present disclosure may apply the multi-view setting only during training and the monocular setting during testing, thereby combining the advantages of both.

For example, the architecture of the present disclosure mixes outputs from two branches of a neural network. A first branch takes a single image (from one camera viewing angle) as input and generates a 3D pose in 3D space; while a second branch inputs a plurality of images from different camera viewing angles, and outputs the estimated 3D pose. The method provided in the present disclosure allows all estimated 3D poses to be projected from both branches to any camera viewing angle.

In some embodiments, the method provided in the present disclosure may include two stages. In a first stage, a 2D pose estimator is used to estimate a 2D human pose; and in a second stage, a 2D estimation result is lifted to 3D space. In combination with geometric information of the camera, a 3D pose from the second branch and a rotation matrix at the viewing angle of the first branch, a desired 3D pose is obtained by rotation and the like in a first camera coordinate system.

In other words, all 3D poses in the real world coordinate system should be identical, so each acquired pose can be projected back into the 3D camera coordinate system of the corresponding camera. Furthermore, by re-projecting the 3D pose to each 2D camera viewing angle through the camera matrix, a reprojection loss can be defined for each 3D to 2D projection.

In some embodiments, the present disclosure proposes a two-branch self-supervision method in a multi-view training setting for training a 2D to 3D lifting network without 3D labeling of data. The technical solution of the present disclosure only relies on geometric knowledge to construct a supervisory signal, so that better generalization capability can be obtained.

In some embodiments, the present disclosure proposes a cyclic view training scheme that is effective in exploiting multi-view consistency information, and in constraining the estimated 3D poses during training. In this way, the depth blurring problem can be overcome, and incomplete or erroneous two-dimensional detection situations can be handled with information from other viewing angles. Furthermore, the present disclosure uses 2D joint confidence of different camera viewing angles to mitigate self-occlusion.

In some embodiments, the present disclosure proposes a volumetric 3DPS network based on a voxel method and 3DPS. The network can explore a sufficient state space where a volumetric cube is generated by grid sampling; and then, the cube is sent to a voxel-based neural network to obtain a 3D pose.

The inventors of the present disclosure have found that the existing art described above has the following problems: the machine learning model requires a large amount of labeled data samples, resulting in a high pose estimation cost. In view of this, the present disclosure proposes a training technical solution for a machine learning model. For example, the technical solution of the present disclosure may be implemented by the following embodiments.

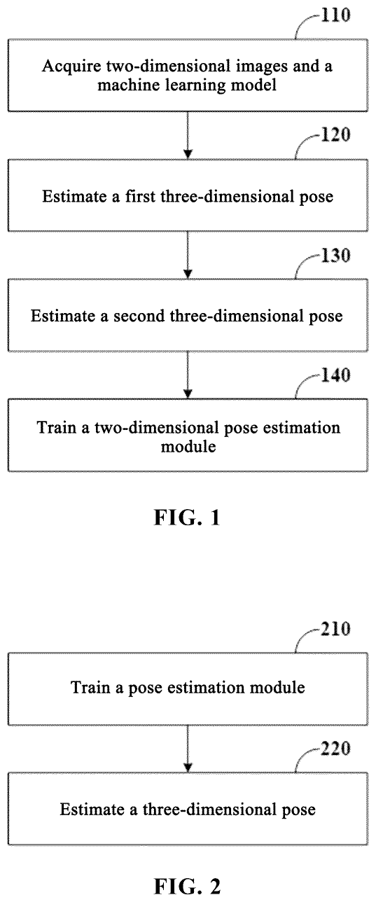

FIG. 1 shows a flowchart of a training method for a machine learning model according to some embodiments of the present disclosure.

As shown in FIG. 1, in step 110, a plurality of two-dimensional images and a machine learning model to be trained are acquired. The plurality of two-dimensional images include a target. The machine learning model includes a first three-dimensional pose estimation module and a second three-dimensional pose estimation module. For example, the target includes a human target, and the plurality of feature points of the human target includes a plurality of joint points.

In some embodiments, the machine learning model includes a first three-dimensional pose estimation module and a second three-dimensional pose estimation module. The first three-dimensional pose estimation module includes a first two-dimensional detection module and a second lifting network module; and the second three-dimensional pose estimation module includes a second two-dimensional detection module and a three-dimensional 3DPS module. The first two-dimensional detection module and the second two-dimensional detection module may be the same or different.

In some embodiments where 4 camera viewing angles are present, there are 4 synchronous camera viewing angles and a camera projection matrix, and all cameras capture two-dimensional images of the same target and the same scene.

For example, the plurality of two-dimensional images processed by the machine learning model are acquired based on the viewing angles and the projection matrix of the plurality of synchronous shooting devices, so that the plurality of two-dimensional images are kept synchronous in time, and the training effect and processing accuracy of the machine learning model are improved.

In step 120, based on any one of the two-dimensional images, the first three-dimensional pose estimation module is used to estimate a first three-dimensional pose of the target. For example, a two-dimensional image is acquired from a first shooting angle of a monocular camera.

Therefore, the training of the first three-dimensional pose estimation module can be completed without labeling training samples. The trained first three-dimensional pose estimation module can accurately estimate the three-dimensional pose of the target under a monocular camera scene without a multi-lens camera, thereby reducing the cost.

In some embodiments, the first three-dimensional pose may include at least one of a three-dimensional heat map or three-dimensional coordinates.

For example, in the case where estimation is made using the trained first three-dimensional pose estimation module, a first three-dimensional pose in the form of three-dimensional coordinates may be output to a user to provide more accurate information to the user. The user may perform subsequent operations, such as behavior recognition, action early warning and the like, according to the three-dimensional coordinates.

For example, during training of the first three-dimensional pose estimation module, a first three-dimensional pose in the form of a three-dimensional heat map may be output. The heat map can represent a range, rather than a fixed point, of a feature point, which provides a higher fault tolerance for the system, and thus improves the training effect of the first three-dimensional pose estimation module.

In some embodiments, based on any one of the two-dimensional images, a first two-dimensional detection module is used to estimate a two-dimensional pose of the target.

For example, a two-dimensional pose estimator is used to predict a two-dimensional pose. For each frame of the two-dimensional image, the two-dimensional image may be clipped based on a bounding box, where the target in the two-dimensional image is located, detected by the two-dimensional detector.

For example, the clipped two-dimensional image at the viewing angle of a first camera in the 4 cameras is represented by I, while the clipped two-dimensional images at the viewing angles of the other 3 cameras are represented by {Ĩ^{c}|c=1,2,3}; and each clipped two-dimensional image is input into the two-dimensional pose estimator to estimate a two-dimensional pose X of the target.

For example, a stem of the two-dimensional pose estimator is denoted by f, and the weight parameter is θ. The two-dimensional pose estimator may consist of two parts: a global network for roughly predicting a two-dimensional pose; and a fine network for refining joints.

In some embodiments, based on any one of the first two-dimensional images, a two-dimensional feature point heat map of the first two-dimensional image is estimated; and the two-dimensional pose is estimated according to the two-dimensional feature point heat map. For example, the two-dimensional pose is estimated by performing soft-argmax processing on the two-dimensional feature point heat map.

For example, the heat map H of I may be estimated by the two-dimensional pose estimator:

$$H = f ( I ; θ )$$

For example, the two-dimensional pose X of the target may be estimated from H. The two-dimensional pose X may be estimated using an argmax algorithm. The argmax algorithm can compute a point with a maximum value in each heat map to obtain a joint with the highest probability.

However, the argmax algorithm may cut off a gradient flow, making it unable to train the 2D pose estimator. For this technical problem, soft-argmax for example, instead of argmax, may be applied to the heat map H:

$${G}_{k} = {e}^{{H}_{k}} / ( {\int }_{i ∈ Ω} {e}^{{H}_{k} ( i )} )$$

Hₖ is a heat map of an k^{th} joint of the target captured by a first camera, and Ω is a domain of the heat map. A position i is weighted by soft-argmax based on a probability Gk(i) corresponding to the position i, to obtain weighted coordinates of the position i; and all the weighted coordinates are added to obtain two-dimensional coordinates of each joint as the two-dimensional pose of the target.

In the above embodiment, the soft-argmax processing can ensure that the gradient flow is transferred from the output three-dimensional pose to the input two-dimensional image, so that the machine learning model will not cut off the gradient flow, thereby improving the accuracy of pose estimation.

In some embodiments, according to the two-dimensional pose of the target, a second lifting network module is used to estimate the first three-dimensional pose. For example, N detected 2D joints are denoted by X∈ [symbol] ^{N×2}, and a three-dimensional pose Y∈ [symbol] ^{N×3} is predicted by a three-dimensional lifting network.

In some embodiments, the second lifting network module includes a batch normalization layer, a dropout layer, a rectified linear layer, and a residual connection layer.

For example, a goal of the lifting network w^{v} is to estimate joint positions of the target in 3D space when only 2D inputs are given. The lifting network may include a batch normalization layer, a dropout layer, a rectified linear layer, and a residual connection layer connected by a residual. An input layer of the lifting network may receive coordinates of N (which is a positive integer such as 17) personal joints, and apply the coordinates to a fully-connected layer with 1024 output channels. Then, processing is performed by the residual connection layer consisting of 4 modules connected by a residual, where each module may consist of two fully-connected layers. Then, processing is performed by the batch normalization layer, the correction linear unit and the dropout layer. Finally, a final feature output from one residual module is input to one linear layer to obtain a three-dimensional pose Y:

$$Y = {w}^{v} ( X )$$

In the above embodiment, a 2D pose estimation network is applied to predict two-dimensional poses and heat maps of a plurality of input frame images. Then, confidences of all 2D feature points is lifted to confidences of 3D feature points to integrate losses of different viewing angles. In this manner, the effects of noise caused by self-occlusion can be mitigated, thereby improving the accuracy of pose estimation.

In step 130, based on at least two of the two-dimensional images, the second three-dimensional pose estimation module is used to estimate a second three-dimensional pose of the target, where the at least two of the two-dimensional images have different viewing angles from each other.

For example, the second three-dimensional pose may include at least one of a three-dimensional heat map of the target or three-dimensional coordinates of each feature point of the target.

In some embodiments, the at least two-dimensional images may be obtained by a monocular camera from different shooting angles, or may be obtained by a multi-lens camera from different shooting angles. For example, the two-dimensional images may be acquired by a monocular camera from a second angle and a third angle, respectively, or by one camera of a binocular camera from the second angle and the other camera of the binocular camera from the third angle, respectively. The second angle is different from the third angle.

In some embodiments, the target includes a plurality of feature points. Based on the at least two of the two-dimensional images, information of a three-dimensional space range in which each of the plurality of feature points of the target is located is estimated; and the second three-dimensional pose is estimated according to the information of the three-dimensional space range. For example, the three-dimensional space range includes a cubic space range, a sphere space range, and the like.

In some embodiments, the three-dimensional space range corresponding to a feature point may be a space range centered at the feature point. For example, a 3DPS network module may be used to estimate a three-dimensional heat map of a position of the feature point, and determine a three-dimensional space range corresponding to the feature point from the three-dimensional heat map.

For example, a size of the three-dimensional space range may be determined based on a preset threshold. A heat threshold may be used to determine a range, in which heats in the three-dimensional heat map of the position of the feature point are greater than the heat threshold, as the three-dimensional space range of the feature point.

In some embodiments, a two-dimensional feature point heat map of each of the at least two-dimensional images is estimated; and the information of the three-dimensional space range is estimated according to the two-dimensional feature point heat map. For example, a 3DPS module is used to estimate the information of the three-dimensional space range.

For example, two-dimensional images Ĩ^{c} input from 3 different camera viewing angles are received, and a two-dimensional heat map \tilde{H}={\tilde{H}^{c}|c=1,2,3} is output for the two-dimensional image of each viewing angle:

$${\tilde{H}}^{c} = f ( {\tilde{I}}^{c} ; θ ) , c = 1 , 2 , 3$$

In some embodiments, The 3DPS module is a multi-view three-dimensional pose prediction method that can explore sufficient state space and generate three-dimensional body part candidates through grid sampling. Then, a two-dimensional pose is predicted by the two-dimensional detector. Then, a three-dimensional pose is generated through two-dimensional prior and maximum likelihood estimation.

In some embodiments, to improve the accuracy and robustness of 3DPS, a volumetric algorithm may be combined with 3DPS to obtain a volumetric 3DPS network for estimating the three-dimensional pose.

For example, the volumetric 3DPS network is used to receive an input two-dimensional heat map \tilde{H} which is processed to output a three-dimensional pose

$$\tilde{Y} = \{ {\tilde{Y}}^{c} ∈ {ℝ}^{N \times 3} \vert c = 1 , 2 , 3 \} .$$

For example, instead of three-dimensional joints, three-dimensional cubes around joints of the body may be sampled by the 3DPS module. The two-dimensional heat map

$${H}_{c}^{k}$$

corresponding to the joint k under a viewing angle c is processed in the 3DPS method to obtain a volumetric cube corresponding to the joint k under the viewing angle c as the cubic space range:

$${V}_{c}^{k} = T ( {H}_{c}^{k} )$$

$${V}_{c}^{k}$$

is a volumetric cube generated from the heat map of the k^{th} joint at a c^{th} camera viewing angle, and T represents the processing in the 3DPS method. For example, the volumetric cube may have a size of 32×32×32.

For example, the volumetric cubes at the respective viewing angles may be summed to yield a sum

$${V}_{k}^{sum}$$

of the volumetric cubes of the target:

$${V}_{k}^{sum} = {\sum }_{c} {V}_{c}^{k}$$

$${V}_{k}^{sum}$$

represents the sum of the volumetric cubes of the joint k at a plurality of viewing angles c.

In some embodiments, a three-dimensional feature point heat map is estimated according to the information of the three-dimensional space range; and the second three-dimensional pose is estimated according to the three-dimensional feature point heat map.

For example, the sum of the volumetric cubes is input into a learnable volumetric convolutional neural network p^{q}. The volumetric convolutional neural network may have an architecture similar to a voxel-to-voxel network. Therefore, a three-dimensional feature point heat map H^{3D} can be obtained:

$${H}^{3 D} = {p}^{q} ( {V}^{sum} )$$

V^{sum} is a concatenation result of sums

$${V}_{k}^{sum}$$

of volumetric cubes of the joint k, and q represents a weight of the voxel-to-voxel network.

In some embodiments, the second three-dimensional pose is estimated by performing soft-argmax processing on the three-dimensional feature point heat map.

For example, soft-argmax is applied to the heat map H^{3D} to obtain a three-dimensional pose

$${G}_{k}^{3 D} :$$

$${G}_{k}^{3 D} = {e}^{{H}_{k}^{3 D}} / ( {\int }_{i ∈ Ω} {e}^{{H}_{k}^{3 D} ( i )} )$$

$${H}_{k}^{3 D}$$

represents an estimated heat map of the k^{th} joint of the target in the three-dimensional space, and Ω represents a domain; and further, a position \tilde{Y}ₖ of the k^{th} three-dimensional joint can be obtained as the three-dimensional pose:

$${\tilde{Y}}_{k} = {\int }_{i ∈ Ω} i \times {G}_{k}^{3 D} ( i )$$

In the above embodiment, a volumetric algorithm (for estimating a three-dimensional space range corresponding to a feature point) and the 3DPS are combined to sample a three-dimensional space range around the feature point of the target, and send the three-dimensional space range to a voxel-based neural network to acquire the three-dimensional pose. In this way, the accuracy and robustness of 3DPS are improved, thereby improving the accuracy of pose estimation.

In step 140, at least one of the first three-dimensional pose estimation module or the second three-dimensional pose estimation module is trained based on a difference between the first three-dimensional pose and the second three-dimensional pose.

In the above embodiment, the machine learning model of the present disclosure is trained in a multi-view setting in a self-supervision manner, so that the machine learning model can benefit from information from different viewing angles, thereby improving the accuracy of pose estimation.

However, since the training data is not labeled with true values of three-dimensional poses, the three-dimensional poses generated from the two branches are difficult to locate at the same absolute three-dimensional position, which may cause difficulty in convergence of the training. In view of the above technical problem, a pre-training scheme may be applied to help locate the three-dimensional poses to ensure that the three-dimensional poses generated by the two branches are located at the same absolute three-dimensional position. For example, the above technical solution may be implemented by the following embodiments.

In some embodiments, a first key point of the first three-dimensional pose and a second key point of the second three-dimensional pose are acquired; based on the first key point and the second key point, the second three-dimensional pose and the first three-dimensional pose are corrected to the same viewing angle; and based on a difference between the corrected first three-dimensional pose and second three-dimensional pose, at least one of the first three-dimensional pose estimation module or the second three-dimensional pose estimation module is trained.

In some embodiments, a first lifting network module is used to estimate the first key point and the second key point. For example, the first key point is at a center position of the first three-dimensional pose, and the second key point is at a center position of the second three-dimensional pose. For example, a human pelvis may be used as a key point at the center position. For example, the first key point and the second key point may be estimated from the respective feature points.

For example, a first lifting network different from the second lifting network module may be used to predict a center position of the three-dimensional pose. The central first lifting network module and the second lifting network may have the same network architecture but different weight parameters. The first lifting network module may include two parts, u^{γ} and ũ^{\tilde{γ}}, where u^{γ} is configured to predict a first key point Y^{pelvis} under a first camera viewing angle, and ũ^{\tilde{γ}} is configured to predict a second key point \tilde{Y}^{pelvis} randomly selected from a second, third and fourth camera viewing angle:

$${Y}^{pelvis} = {u}^{γ} ( X )$$

$${\tilde{Y}}^{pelvis} = {\tilde{u}}^{\tilde{γ}} ( \tilde{X} )$$

\tilde{X} is a predicted two-dimensional pose at a randomly selected viewing angle. The predicted key points may then be used to locate the three-dimensional pose, and move the three-dimensional pose to a predicted position during training, to ensure that the second three-dimensional pose and the first three-dimensional pose are corrected to the same viewing angle.

In some embodiments, the second three-dimensional pose is corrected to the viewing angle of the first three-dimensional pose to generate a third three-dimensional pose, so that at least one of the first three-dimensional pose estimation module or the second three-dimensional pose estimation module is trained based on a difference between the third three-dimensional pose and the first three-dimensional pose.

For example, a correspondence relationship between the feature points on the second three-dimensional pose and the first three-dimensional pose may be determined; and then single line alignment is performed based on the first key point and the second key point, and positions of the feature points in correspondence on edges of the second three-dimensional pose and the first three-dimensional pose. In this manner, the viewing angles of the second three-dimensional pose and the first three-dimensional pose are ensured to be the same, thereby improving the accuracy of pose estimation.

In some embodiments, a mean square error (MSE) loss and a two-dimensional reprojection loss are determined based on a difference between the first three-dimensional pose and the second three-dimensional pose; and according to a weighted average of the MSE loss and the two-dimensional reprojection loss, at least one of the first three-dimensional pose estimation module or the second three-dimensional pose estimation module is trained until a training end condition is met.

For example, two different loss functions, 3D MSE loss and 2D reprojection loss, may be applied to train the machine learning model. The reprojection loss can further constrain the consistency of multiple viewing angles, thereby improving the performance of the machine learning model.

The reason is that, without depth information, multiple possibilities of the two-dimensional detector corresponding to three-dimensional poses in different directions can be constrained to the correct direction through 2D reprojection by using information from other viewing angles, thereby improving the performance of the machine learning model.

For example, the MSE loss may be:

$${L}_{mse}^{3 D} = {\sum }_{k = 1}^{K} \frac{1}{\vert {Y}_{k} \vert} {‖ {Y}_{k} - {\tilde{Y}}_{k} ‖}_{F}^{2}$$

Yₖ is the first three-dimensional pose of a feature point k, and \tilde{Y}ₖ is the second three-dimensional pose of the feature point k.

For example, the 2D reprojection loss is:

$${L}_{repj}^{2 D} = {\sum }_{k = 1}^{K} {\sum }_{c = 1}^{C} \frac{1}{\vert {y}_{c}^{( k )} \vert} {‖ {\tilde{y}}_{c}^{( k )} - {y}_{c}^{( k )} ‖}_{F}^{2}$$

$${\tilde{y}}_{c}^{( k )} = [ {p}_{1} \cdot \frac{[ \begin{matrix}{Y}_{k} \\ 1\end{matrix} ]}{{p}_{3}} \cdot [ \begin{matrix}{Y}_{k} \\ 1\end{matrix} ] , {p}_{2} \cdot \frac{[ \begin{matrix}{Y}_{k} \\ 1\end{matrix} ]}{{p}_{3}} \cdot [ \begin{matrix}{Y}_{k} \\ 1\end{matrix} ] ]$$

$${P}_{c} - {[ {p}_{1} {p}_{2} {p}_{3} ]}^{T} .$$

p₁ p₂ p₃ represents coordinate conversion information required for coordinate conversion.

In some embodiments, a total loss for training the machine learning model is:

$$L = {L}_{mse}^{3 D} + α {L}_{repj}^{2 D}$$

α is a weight coefficient set as needed to adjust the importance of the two losses in training.

FIG. 2 shows a schematic diagram of a training method for a machine learning model according to some other embodiments of the present disclosure.

As shown in FIG. 2, in step 210, a first three-dimensional pose estimation module of a machine learning model is trained in the training method according to any of the above embodiments.

In step 220, two-dimensional images containing a target are acquired; and based on the two-dimensional images, the trained first three-dimensional pose estimation module is used to estimate a three-dimensional pose of the target.

In some embodiments, a usage requirement of the machine learning model is acquired; and the machine learning model is converted to a format matched with the usage requirement.

In some embodiments, in response to a setting operation of a user, a deployment environment and model parameters of the machine learning model are set.

In some embodiments, the three-dimensional pose is displayed.

In some embodiments, the target includes a plurality of feature points, and based on at least two of the two-dimensional images, information of a three-dimensional space range in which each of the plurality of feature points of the target is located is estimated; and the second three-dimensional pose is estimated according to the information of the three-dimensional space range.

In some embodiments, a two-dimensional feature point heat map of each of the at least two-dimensional images is estimated; and the information of the three-dimensional space range is estimated according to the two-dimensional feature point heat map.

In some embodiments, a three-dimensional feature point heat map is estimated according to the information of the three-dimensional space range; and the second three-dimensional pose is estimated according to the three-dimensional feature point heat map.

In some embodiments, the second three-dimensional pose is estimated by performing soft-argmax processing on the three-dimensional feature point heat map.

In some embodiments, the three-dimensional space range includes a cubic space range.

In some embodiments, a 3DPS module is used to estimate the information of the three-dimensional space range.

In some embodiments, a first key point of the first three-dimensional pose and a second key point of the second three-dimensional pose are acquired; based on the first key point and the second key point, the second three-dimensional pose and the first three-dimensional pose are corrected to the same viewing angle; and based on a difference between the corrected first three-dimensional pose and second three-dimensional pose, at least one of the first three-dimensional pose estimation module or the second three-dimensional pose estimation module is trained.

In some embodiments, the second three-dimensional pose is corrected to the viewing angle of the first three-dimensional pose to generate a third three-dimensional pose, so that at least one of the first three-dimensional pose estimation module or the second three-dimensional pose estimation module is trained based on a difference between the third three-dimensional pose and the first three-dimensional pose.

In some embodiments, a first lifting network module is used to estimate the first key point and the second key point.

In some embodiments, the first key point is at a center position of the first three-dimensional pose, and the second key point is at a center position of the second three-dimensional pose.

In some embodiments, based on any one of the two-dimensional images, a first two-dimensional detection module is used to estimate a two-dimensional pose of the target; and according to the two-dimensional pose of the target, a second lifting network module is used to estimate the first three-dimensional pose.

In some embodiments, based on any one of the first two-dimensional images, a two-dimensional feature point heat map of the first two-dimensional image is estimated; and the two-dimensional pose is estimated according to the two-dimensional feature point heat map.

In some embodiments, the two-dimensional pose is estimated by performing soft-argmax processing on the two-dimensional feature point heat map.

In some embodiments, the second lifting network module includes a batch normalization layer, a dropout layer, a rectified linear layer, and a residual connection layer.

In some embodiments, a mean square error (MSE) loss and a two-dimensional reprojection loss are determined based on a difference between the first three-dimensional pose and the second three-dimensional pose; and according to a weighted average of the MSE loss and the two-dimensional reprojection loss, at least one of the first three-dimensional pose estimation module or the second three-dimensional pose estimation module is trained until a training end condition is met.

In some embodiments, the target includes a human target, and the plurality of feature points of the human target includes a plurality of joint points.

In some embodiments, at least one of the first three-dimensional pose or the second three-dimensional pose is displayed.

FIG. 3 shows a schematic diagram of a training method for a machine learning model according to some embodiments of the present disclosure.

As shown in FIG. 3, the machine learning model consists of two branches, where a first branch inputs a single two-dimensional image (from one camera viewing angle) at a first camera viewing angle, and generates a first 3D pose in 3D space; and a second branch inputs three two-dimensional images from other 3 camera viewing angles, and outputs an estimated second 3D pose. The second 3D pose may be rotated to the first camera viewing angle to achieve a consistent loss at multiple viewing angles. In this manner, 3D poses estimated at different viewing angles correspond to the same skeleton before geometric transformation. The predicted 3D pose may be reprojected to each camera viewing angle to obtain additional reprojection errors.

In some embodiments, the machine learning model includes the two-dimensional detector, the lifting network, and the volumetric 3DPS network in FIG. 3. The two-dimensional detector includes the first two-dimensional detection module and the second two-dimensional detection module in any of the above embodiments. The lifting network includes the second lifting network module in any of the above embodiments. The volumetric 3DPS network includes the 3DPS module in any of the above embodiments.

For example, the first three-dimensional pose estimation module includes the two-dimensional detector and the lifting network of FIG. 3; and the second three-dimensional pose estimation module includes the two-dimensional detector and the volumetric 3DPS network of FIG. 3.

In some embodiments, the two-dimensional detector is used to predict two-dimensional poses and two-dimensional heat maps of two-dimensional image frames from 4 inputs; and then, the lifting network is used to lift the confidence of each two-dimensional feature point to be three-dimensional.

FIG. 3 shows a network architecture for 4 camera viewing angles. There are 4 synchronous camera viewing angles and a camera projection matrix, and all cameras capture the same target and the same scene. First, the two-dimensional detector is used to obtain a two-dimensional pose. For each frame of the two-dimensional image, the two-dimensional image is clipped based on a bounding box of the target detected by the two-dimensional detector.

For example, the clipped two-dimensional image at the viewing angle of a first camera in the 4 cameras is represented by I, while the clipped two-dimensional images at the viewing angles of the other 3 cameras are represented by {Ĩ^{c}|c=1,2,3}; and each clipped two-dimensional image is input into the two-dimensional pose estimator to estimate a two-dimensional pose X of the target. For example, a stem of the two-dimensional pose estimator is denoted by f, and the weight parameter is θ. The two-dimensional pose estimator may consist of two parts: a global network for roughly predicting a two-dimensional pose; and a fine network for refining joints.

As shown in FIG. 3, the training process has two branches. In a first branch, X∈ [symbol] ^{N×2} represents N detected 2D joints; and then, a three-dimensional pose Y∈ [symbol] ^{N×3} is predicted by a three-dimensional lifting network. In the other branch, two-dimensional images input from 3 camera viewing angles are received, and a two-dimensional heat map \tilde{H}={\tilde{H}^{c}|c=1,2,3} is output for each viewing angle; and then, a volumetric 3DPS network is used to receive the input heat maps and output a three-dimensional pose \tilde{Y}={\tilde{Y}^{c}∈ [symbol] ^{N×3}|c=1,2,3}. The heat map may be estimated by the two-dimensional detector:

$$H = f ( I ; θ ) ,$$

$${\tilde{H}}^{c} = f ( {\tilde{I}}^{c} ; θ ) , c = 1 , 2 , 3 ,$$

The two-dimensional pose X for the first branch is estimated from H. The two-dimensional pose X may be estimated using an argmax algorithm. The argmax algorithm can compute a point with a maximum value in each heat map to obtain a joint with the highest probability.

However, the argmax algorithm may cut off a gradient flow, making it unable to train the 2D pose estimator. For this technical problem, soft-argmax for example, instead of argmax, may be applied to the heat map H:

$${G}_{k} = {e}^{{H}_{k}} / ( {\int }_{i ∈ Ω} {e}^{{H}_{k} ( i )} )$$

In some embodiments, the estimation of the three-dimensional pose may be centered around zero, and values of Y and \tilde{Y} represent a three-dimensional position relative to a fixed root joint. The predicted three-dimensional pose is in its own pose coordinate system during training, and then \tilde{Y} is rotated to first camera coordinates to obtain a three-dimensional loss. By reprojecting the global three-dimensional pose into two-dimensional space, a reprojection loss for the pose at each viewing angle is obtained.

For example, a goal of the lifting network w^{v} is to estimate joint positions of the target in 3D space when only 2D inputs are given. The lifting network may include a batch normalization layer, a dropout layer, a rectified linear layer, and a residual connection layer connected by a residual. An input layer of the lifting network may receive coordinates of N (which is a positive integer such as 17) personal joints, and apply the coordinates to a fully-connected layer with 1024 output channels. Then, processing is performed by the residual connection layer consisting of 4 modules connected by a residual, where each module may consist of two fully-connected layers. Then, processing is performed by the batch normalization layer, the correction linear unit and the dropout layer. Finally, a final feature output from one residual module is input to one linear layer to obtain a three-dimensional pose Y:

$$Y = {w}^{v} ( X )$$

The 3DPS module is a multi-view three-dimensional pose prediction method that can explore sufficient state space and generate three-dimensional body part candidates through grid sampling. Then, a two-dimensional pose is predicted by the two-dimensional detector. Then, a three-dimensional pose is generated through two-dimensional prior and maximum likelihood estimation.

To improve the accuracy and robustness of 3DPS, a volumetric algorithm may be combined with 3DPS to obtain a volumetric 3DPS network for estimating the three-dimensional pose. Instead of three-dimensional joints, three-dimensional cubes around joints of the human body may be sampled by the 3DPS module. The two-dimensional heat map

$${H}_{c}^{k}$$

corresponding to me joint k under a viewing angle c is processed in the 3DPS method to obtain a volumetric cube corresponding to the joint k under the viewing angle c as the cubic space range:

$${V}_{c}^{k} = T ( {H}_{c}^{k} )$$

$${V}_{c}^{k}$$

is a volumetric cube generated from the heat map of the k^{th} joint at a c^{th} camera viewing angle, and T represents the processing in the 3DPS method. For example, the volumetric cube may have a size of 32×32×32.

For example, the volumetric cubes at the respective viewing angles may be summed to yield a sum

$${V}_{k}^{sum}$$

of the volumetric cubes of the target:

$${V}_{k}^{sum} = {\sum }_{c} {V}_{c}^{k}$$

$${V}_{k}^{sum}$$

represents the sum of the volumetric cubes of the joint k at a plurality of viewing angles c.

The sum of the volumetric cubes is input into a learnable volumetric convolutional neural network p^{q}. The volumetric convolutional neural network may have an architecture similar to a voxel-to-voxel network. Therefore, a three-dimensional feature point heat map H^{3D} can be obtained:

$${H}^{3 D} = {p}^{q} ( {V}^{sum} )$$

V^{sum} is a concatenation result of sums

$${V}_{k}^{sum}$$

of volumetric cubes of the joint k, and q represents a weight of the voxel-to-voxel network.

Soft-argmax is applied to the heat map H^{3D} to obtain a three-dimensional pose

$${G}_{k}^{3 D} :$$

$${G}_{k}^{3 D} = {e}^{{H}_{k}^{3 D}} / ( {\int }_{i ∈ Ω} {e}^{{H}_{k}^{3 D} ( i )} )$$

$${H}_{k}^{3 D}$$

represents an estimated heat map of the k^{th} joint of the target in the three-dimensional space, and Ω represents a domain; and further, a position \tilde{Y}ₖ of the k^{th} three-dimensional joint can be obtained as the three-dimensional pose:

$${\tilde{Y}}_{k} = {\int }_{i ∈ Ω} i \times {G}_{k}^{3 D} ( i )$$

For example, a L2 norm

$${‖ ‖}_{F}^{2}$$

between the predicted three-dimensional poses at different viewing angles is used to ensure the multi-view consistency. If the prediction result is accurate, the loss should be zero. The reason is that the same target captured from different camera viewing angles should have the same absolute 3D pose in 3D space.

However, this solution works poorly in the case of more than two viewing angles. During the training process, the L2 norm loss between the viewing angle of a two-dimensional image 1 and the viewing angle of a two-dimensional image 2 will conflict with the L2 norm loss between the viewing angle of the two-dimensional image 2 and the viewing angle of a two-dimensional image 3. The reason is that when the depth information of the camera viewing angle is not available, the lifting network learns the three-dimensional pose applicable to only one viewing angle.

In view of the above technical problem, the three-dimensional poses generated at different camera viewing angles can be converted into the same three-dimensional pose. For example, a cyclic view training scheme may be adopted. The machine learning model in FIG. 3 consists of 2 branches, with a first branch including a camera viewing angle, followed by a lifting network; and a second branch including 3 camera viewing angles, followed by a volumetric 3DPS network. The input two-dimensional images for these 4 viewing angles can be randomly swapped so that all possible three-dimensional viewing angle combinations can be trained to solve the multi-view consistency problem.

For example, after a round of training is performed in the training method according to any of the above embodiments, one two-dimensional image may be selected from the at least two-dimensional images in a previous round of training as the first two-dimensional image, a remaining one of the at least two-dimensional images may be determined as the second two-dimensional image, and any one of the two-dimensional images in the previous round of training may be determined as the second two-dimensional image. Based on the first two-dimensional image, the first three-dimensional pose estimation module is used to estimate a first three-dimensional pose of the target in this round of training. Based on the second two-dimensional image, the second three-dimensional pose estimation module is used to estimate a second three-dimensional pose of the target in this round of training. Based on a difference between the first three-dimensional pose trained in this round and training and the second three-dimensional pose trained in this round of training, at least one of the first three-dimensional pose estimation module or the second three-dimensional pose estimation module is trained.

In the above embodiment, the machine learning model of the present disclosure is trained in a multi-view setting in a self-supervision manner, so that the machine learning model can benefit from information from different viewing angles, thereby improving the accuracy of pose estimation.

However, since the training data is not labeled with true values of three-dimensional poses, the three-dimensional poses generated from the two branches are difficult to locate at the same absolute three-dimensional position, which may cause difficulty in convergence of the training. In view of the above technical problem, a pre-training scheme may be applied to help locate the three-dimensional poses to ensure that the three-dimensional poses generated by the two branches are located at the same absolute three-dimensional position.

For example, a first lifting network different from the second lifting network module may be used to predict a center position of the three-dimensional pose. The central first lifting network module and the second lifting network may have the same network architecture but different weight parameters. The first lifting network module may include two parts, u^{γ} and ũ^{\tilde{γ}} where u^{γ} is configured to predict a first key point Y^{pelvis} under a first camera viewing angle, and ũ^{\tilde{γ}} is configured to predict a second key point \tilde{Y}^{pelvis} randomly selected from a second, third and fourth camera viewing angle:

$${Y}^{pelvis} = {u}^{γ} ( X )$$

$${\tilde{Y}}^{pelvis} = {\tilde{u}}^{\tilde{γ}} ( \tilde{X} )$$

The predicted key points may then be used to locate the three-dimensional pose, and move the three-dimensional pose to a predicted position during training, to ensure that the second three-dimensional pose and the first three-dimensional pose are corrected to the same viewing angle.

For example, the double arrow between the first three-dimensional pose and the third three-dimensional pose in FIG. 3 may represent training the machine learning model by comparing the difference between the first three-dimensional pose and the third three-dimensional pose.

For example, the three-dimensional heat map generated by the lifting network may be processed by soft-argmax to obtain the first three-dimensional pose. The soft-argmax processing can ensure that the gradient flow is transferred from the output three-dimensional pose to the input two-dimensional image, so that the machine learning model will not cut off the gradient flow.

Two different loss functions, 3D MSE loss and 2D reprojection loss, may be applied to train the machine learning model. The reprojection loss can further constrain the consistency of multiple viewing angles, thereby improving the performance of the machine learning model.

The reason is that without depth information, multiple possibilities of the two-dimensional detector corresponding to three-dimensional poses in different directions can be constrained to the correct direction through 2D reprojection by using information from other viewing angles, thereby improving the performance of the machine learning model.

For example, the MSE loss may be:

$${L}_{mse}^{3 D} = {\sum }_{k = 1}^{K} \frac{1}{\vert {Y}_{k} \vert} {‖ {Y}_{k} - {\tilde{Y}}_{k} ‖}_{F}^{2}$$

Yₖ is the first three-dimensional pose of a feature point k, and \tilde{Y}ₖ is the second three-dimensional pose of the feature point k.

For example, the 2D reprojection loss is:

$${L}_{repj}^{2 D} = {{\sum }_{k = 1}}^{K} {\sum }_{c = 1}^{C} \frac{1}{\vert {y}_{c}^{( k )} \vert} {‖ {\tilde{y}}_{c}^{( k )} - {y}_{c}^{( k )} ‖}_{F}^{2}$$

$${\tilde{y}}_{c}^{( k )} = [ {p}_{1} \cdot \frac{[ \begin{matrix}{Y}_{k} \\ 1\end{matrix} ]}{{p}_{3}} \cdot [ \begin{matrix}{Y}_{k} \\ 1\end{matrix} ] , {p}_{2} \cdot \frac{[ \begin{matrix}{Y}_{k} \\ 1\end{matrix} ]}{{p}_{3}} \cdot [ \begin{matrix}{Y}_{k} \\ 1\end{matrix} ] ]$$

$${P}_{c} = {[ {p}_{1} {p}_{2} {p}_{3} ]}^{T} .$$

p₁ p₂ p₃ represents coordinate conversion information required for coordinate conversion.

In some embodiments, a total loss for training the machine learning model is:

$$L = {L}_{mse}^{3 D} + α {L}_{repj}^{2 D}$$

α is a weight coefficient set as needed to adjust the importance of the two losses in training.

For example, the multi-view estimation method for a three-dimensional pose may use input two-dimensional images from multiple different viewing angles, and therefore has better performance than the method using a monocular camera viewing angle.

In some embodiments, in the training phase, a cyclic view may be used to assist in trimming a single view procedure and a voxel V2V 3DPS (i.e., volumetric 3DPS) neural network. The volumetric 3DPS network includes a 3DPS module, and a V2V network for estimating a cube with feature points.

For example, the multi-view setting may be used only during the training phase, and only the single-view setting is used during the testing phase. In this manner, the three-dimensional pose estimation model can be trained without labeling 3D data.

For example, the reprojection loss helps constrain multi-view information during training. Through the voxel V2V 3DPS neural network and the cyclic view based training process, the technical problem caused by data labeling can be avoided, and a labeling-free training process can be implemented, thereby reducing the training cost and threshold.

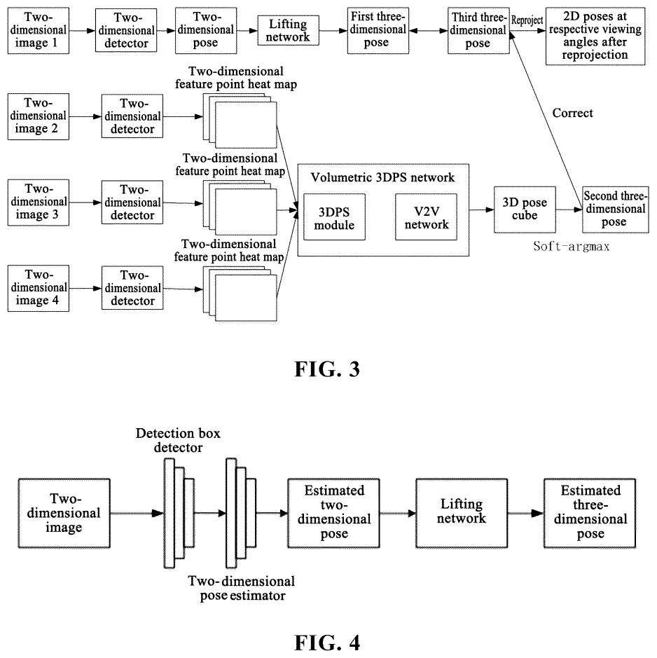

FIG. 4 shows a schematic diagram of an estimation method for a three-dimensional pose according to some embodiments of the present disclosure.

As shown in FIG. 4, the machine learning model inputs each frame of the input two-dimensional image to a detection box detector to acquire the clipped two-dimensional images, and inputs them to a backbone network of the two-dimensional pose estimator. Then, the estimated two-dimensional pose is input to the lifting network to obtain an estimated three-dimensional pose. For example, the multi-view setting is only applicable for the training phase, while the monocular camera setting is adopted in the testing phase.

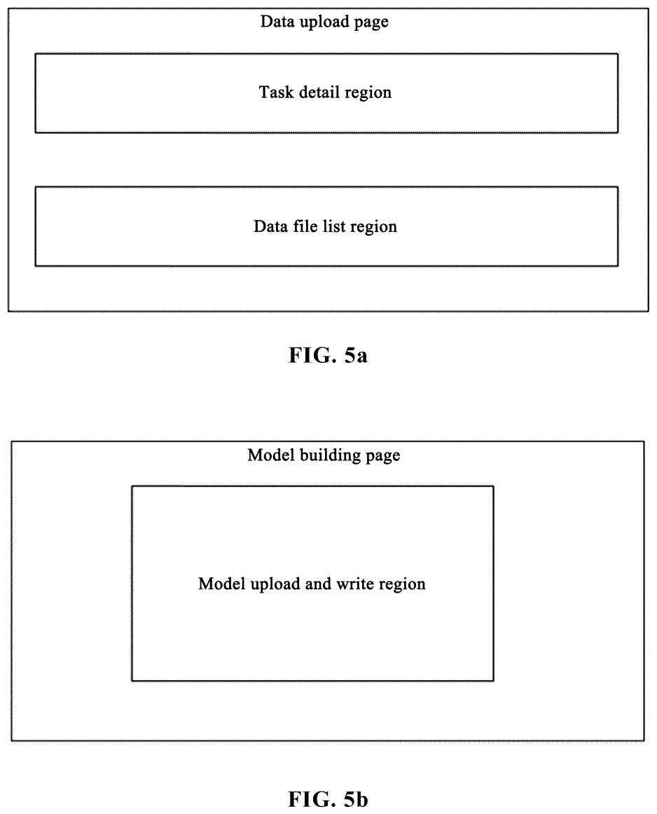

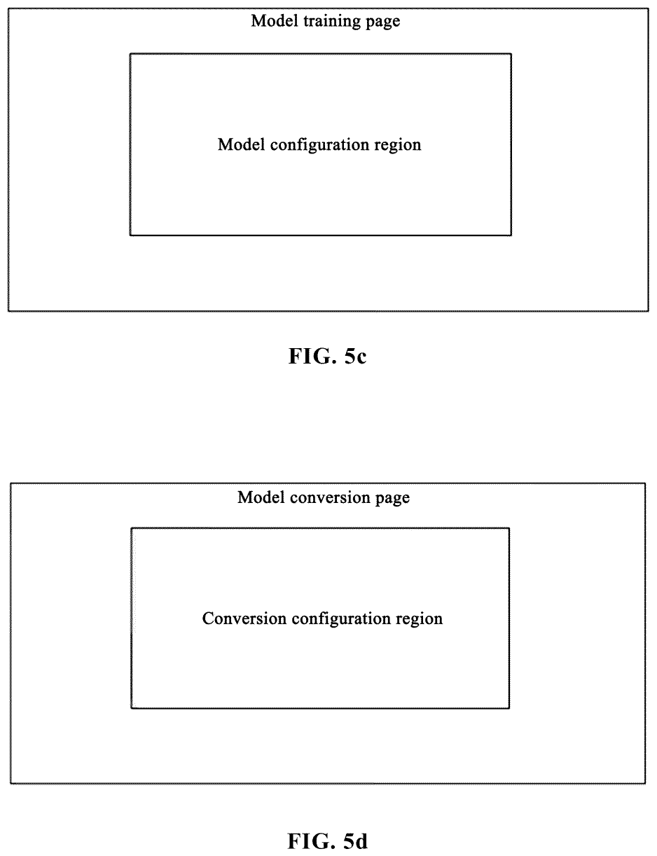

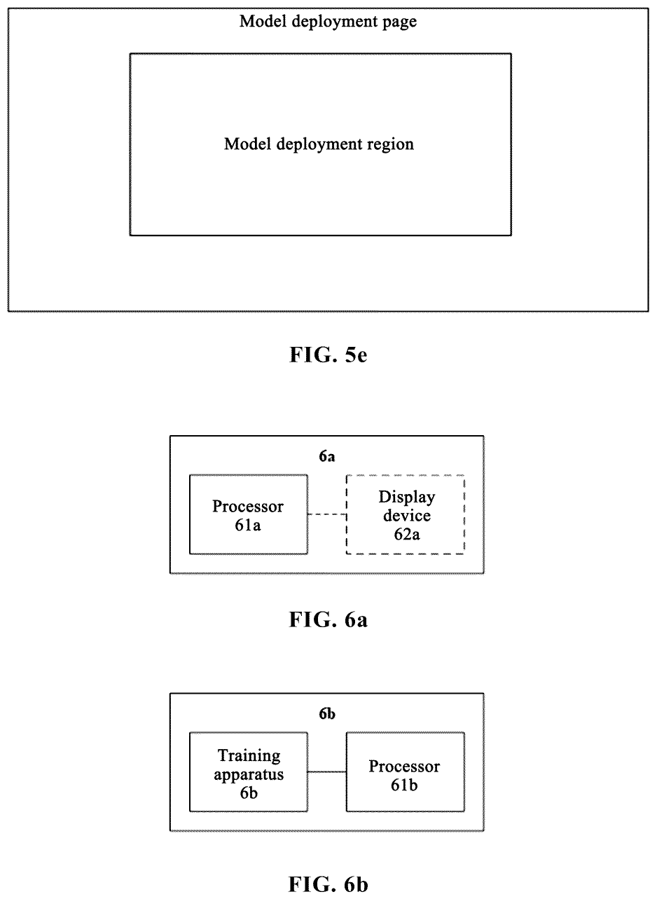

FIGS. 5a to 5e show schematic diagrams of a machine learning model development and deployment platform according to some embodiments of the present disclosure.

As shown in FIG. 5a, pedestrian data maps (i.e., two-dimensional images) at multiple viewing angles are uploaded on a data upload page, and a time sequence correspondence relationship of the pedestrian data maps is established based on a corresponding naming rule. During uploading of the data, no other manual data labeling than the time sequence information transmitted by the camera itself is required to support the subsequent training process and test deployment.

For example, the data upload page includes a task detail region and a data file list region. The task detail region may include information related to a current training task, and the data file list region may include information related to the uploaded data.

As shown in FIG. 5b, on a model building page, codes of the machine learning model to be trained are uploaded, written, and the like through a notebook. The uploaded codes may include codes for settings of training and testing of the model and related procedures.

For example, a model upload and write region on the model building page includes information related to the notebook, information related to the development environment, and the like.

As shown in FIG. 5c, on a model training page, corresponding design and adjustment are made to corresponding parameters of the model. In training of the model, viewing angles of multiple branches are needed to assist the training process, so that the training per se can achieve a better effect while no training label is needed.

For example, a model configuration region on the model training page includes a configuration function for a training task, a configuration function for a lithium resource, and the like.

As shown in FIG. 5d, on a model conversion page, if a user needs model conversion, the training model may be converted to facilitate subsequent deployment. For example, the machine learning model may be converted from pytorch or the like to ONNX or the like. When the model is deployed, the usage requirements of different customers can be met through model conversion and precision correction.

For example, a conversion configuration region of the model conversion page includes information related to the machine learning model and a conversion configuration function.

As shown in FIG. 5e, on a model deployment page, the trained model is selected, and the relevant deployment environment and relevant parameters are set, to ensure that the model can operate properly when being called.

For example, the machine learning model may use a hypertext transfer protocol (HTTP) mode. A test input to the model may be a pedestrian picture at a single viewing angle. The trained model may identify a 3D pose of the pedestrian in the current picture to provide a basis for subsequent action identification or behavior analysis.

In the deployment stage, the model only needs to use a single-flow weight model in a test file to adapt to the requirements in a real environment and reduce the hardware cost and conditions required by operation.

For example, a model deployment region on the model deployment page includes information related to the model and information related to a service to be processed.

FIG. 6a shows a block diagram of a training apparatus for a machine learning model according to some embodiments of the present disclosure.

As shown in FIG. 6a, a training apparatus 6a for a machine learning model includes at least one processor 61a configured to: acquire a plurality of two-dimensional images and a machine learning model to be trained, where the plurality of two-dimensional images include a target, and the machine learning model includes a first three-dimensional pose estimation module and a second three-dimensional pose estimation module; based on any one of the two-dimensional images, use the first three-dimensional pose estimation module to estimate a first three-dimensional pose of the target; based on at least two of the two-dimensional images, use the second three-dimensional pose estimation module to estimate a second three-dimensional pose of the target, where the at least two of the two-dimensional images have different viewing angles from each other; and train, based on a difference between the first three-dimensional pose and the second three-dimensional pose, at least one of the first three-dimensional pose estimation module or the second three-dimensional pose estimation module.

In some embodiments, the target includes a plurality of feature points, and based on at least two of the two-dimensional images, information of a three-dimensional space range in which each of the plurality of feature points of the target is located is estimated; and the second three-dimensional pose is estimated according to the information of the three-dimensional space range.

In some embodiments, a two-dimensional feature point heat map of each of the at least two-dimensional images is estimated; and the information of the three-dimensional space range is estimated according to the two-dimensional feature point heat map.

In some embodiments, a three-dimensional feature point heat map is estimated according to the information of the three-dimensional space range; and the second three-dimensional pose is estimated according to the three-dimensional feature point heat map.

In some embodiments, the second three-dimensional pose is estimated by performing soft-argmax processing on the three-dimensional feature point heat map.

In some embodiments, the three-dimensional space range includes a cubic space range.

In some embodiments, a 3DPS module is used to estimate the information of the three-dimensional space range.

In some embodiments, a first key point of the first three-dimensional pose and a second key point of the second three-dimensional pose are acquired; based on the first key point and the second key point, the second three-dimensional pose and the first three-dimensional pose are corrected to the same viewing angle; and based on a difference between the corrected first three-dimensional pose and second three-dimensional pose, at least one of the first three-dimensional pose estimation module or the second three-dimensional pose estimation module is trained.

In some embodiments, the second three-dimensional pose is corrected to the viewing angle of the first three-dimensional pose to generate a third three-dimensional pose, so that at least one of the first three-dimensional pose estimation module or the second three-dimensional pose estimation module is trained based on a difference between the third three-dimensional pose and the first three-dimensional pose.

In some embodiments, a first lifting network module is used to estimate the first key point and the second key point.

In some embodiments, the first key point is at a center position of the first three-dimensional pose, and the second key point is at a center position of the second three-dimensional pose.

In some embodiments, based on any one of the two-dimensional images, a first two-dimensional detection module is used to estimate a two-dimensional pose of the target; and according to the two-dimensional pose of the target, a second lifting network module is used to estimate the first three-dimensional pose.

In some embodiments, based on any one of the first two-dimensional images, a two-dimensional feature point heat map of the first two-dimensional image is estimated; and the two-dimensional pose is estimated according to the two-dimensional feature point heat map.

In some embodiments, the two-dimensional pose is estimated by performing soft-argmax processing on the two-dimensional feature point heat map.

In some embodiments, the second lifting network module includes a batch normalization layer, a dropout layer, a rectified linear layer, and a residual connection layer.

In some embodiments, a mean square error (MSE) loss and a two-dimensional reprojection loss are determined based on a difference between the first three-dimensional pose and the second three-dimensional pose; and according to a weighted average of the MSE loss and the two-dimensional reprojection loss, at least one of the first three-dimensional pose estimation module or the second three-dimensional pose estimation module is trained until a training end condition is met.

In some embodiments, the target includes a human target, and the plurality of feature points of the human target includes a plurality of joint points.

In some embodiments, the training apparatus 6a further includes: a display device 62a configured to display at least one of the first three-dimensional pose or the second three-dimensional pose.

FIG. 6b shows a block diagram of an estimation apparatus for a three-dimensional pose according to some embodiments of the present disclosure.

As shown in FIG. 6b, in some embodiments, an estimation apparatus 6b for a three-dimensional pose includes: the training apparatus 6a for a machine learning model according to any of the above embodiments, which is configured to train a first three-dimensional pose estimation module of a machine learning model; and at least one processor 61b configured to: acquire a two-dimensional image containing a target; and based on the two-dimensional image, use the trained first three-dimensional pose estimation module to estimate a three-dimensional pose of the target.

In some embodiments, the processor 61b is configured to: acquire a usage requirement of the machine learning model; and convert the machine learning model to a format matched with the usage requirement.

In some embodiments, the processor 61b is configured to: in response to a setting operation of a user, set a deployment environment and model parameters of the machine learning model.

In some embodiments, the display device 62a is configured to display the three-dimensional pose.

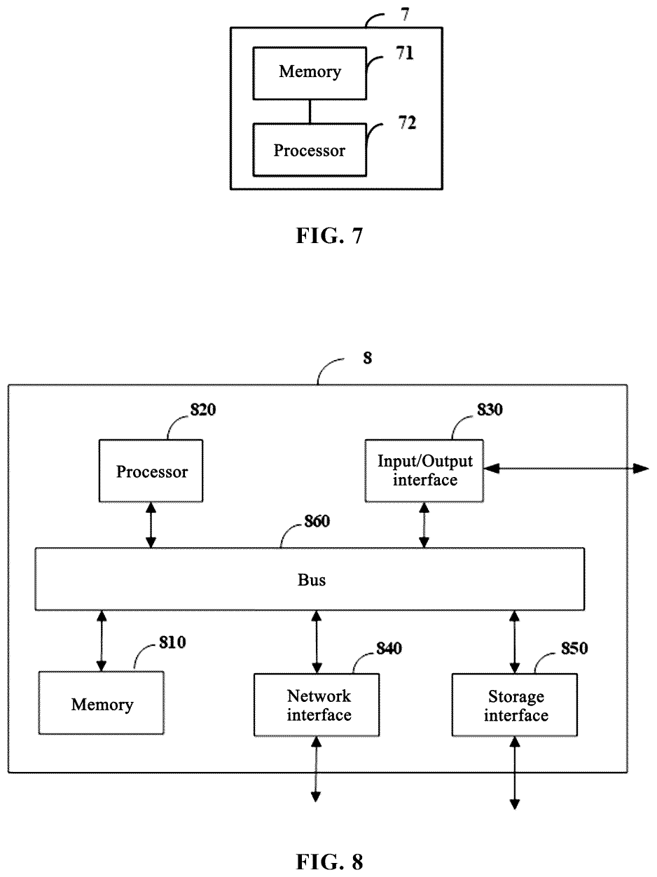

FIG. 7 shows a block diagram of some embodiments of an electronic device according to the present disclosure.

As shown in FIG. 7, an electronic device 7 of this embodiment includes: a memory 71, and a processor 72 coupled to the memory 71 and configured to perform the training method for a machine learning model or the estimation method for a three-dimensional pose according to any of the above embodiments of the present disclosure based on instructions stored in the memory 71.

The memory 71 may include, for example, a system memory, a fixed non-volatile storage medium, and the like. The system memory stores, for example, an operating system, an application, a boot loader, a database, and other programs.

FIG. 8 shows a block diagram of some other embodiments of an electronic device according to the present disclosure.

As shown in FIG. 8, an electronic device 8 of this embodiment includes: a memory 810, and a processor 820 coupled to the memory 810 and configured to perform the training method for a machine learning model or the estimation method for a three-dimensional pose according to any of the above embodiments based on instructions stored in the memory 810.

The memory 810 may include, for example, a system memory, a fixed non-volatile storage medium, and the like. The system memory stores, for example, an operating system, an application, a boot loader, and other programs.

The electronic device 8 may further include an input/output interface 830, a network interface 840, a storage interface 850, and the like. These interfaces 830, 840, 850, and the memory 810 and the processor 820 may be connected via a bus 860, for example. The input/output interface 830 provides a connection interface for input/output devices such as a display, a mouse, a keyboard, a touch screen, a microphone, a sound box, and the like. The network interface 840 provides a connection interface for a variety of networking devices. The storage interface 850 provides a connection interface for external storage devices such as an SD card, a USB stick, and the like.

Those skilled in the art will appreciate that embodiments of the present disclosure may be provided as a method, a system, or a computer program product. Accordingly, the present disclosure may take the form of a pure hardware embodiment, a pure software embodiment, or a combination embodiment of software and hardware. Moreover, the present disclosure may take the form of a computer program product embodied on one or more computer-usable non-transitory storage media (including but not limited to disk storage, CD-ROM, and optical storage, etc.) including a computer-usable program code.

So far, the present disclosure has been described in detail. Some details well known in the art have been omitted to avoid obscuring the concepts of the present disclosure. Those skilled in the art can fully appreciate how to implement the technical solutions disclosed herein in view of the foregoing description.

The method and system of the present disclosure may be implemented in various manners. For example, the method and system of the present disclosure may be implemented in software, hardware, firmware, or any combination of software, hardware, and firmware. The above-described order for the steps of the method is for illustration only, and the steps in the method of the present disclosure are not limited to the order specifically described above unless specifically stated otherwise. Further, in some embodiments, the present disclosure may be embodied as programs recorded in a recording medium, the programs including machine-readable instructions for implementing the method according to the present disclosure. Therefore, the present disclosure also covers a recording medium storing programs for executing the method of the present disclosure.

Although some specific embodiments of the present disclosure have been described in detail by way of example, it should be understood by those skilled in the art that the above examples are for illustration only and are not intended to limit the scope of the present disclosure. It will be appreciated by those skilled in the art that modifications can be made to the above embodiments without departing from the scope and spirit of the present disclosure. The scope of the present disclosure is defined by the appended claims.

1. A training apparatus for a machine learning model, comprising at least one processor configured to:
acquire a plurality of two-dimensional images and a machine learning model to be trained, wherein the plurality of two-dimensional images comprise a target, and the machine learning model comprises a first three-dimensional pose estimation module and a second three-dimensional pose estimation module;
based on any one of the two-dimensional images, use the first three-dimensional pose estimation module to estimate a first three-dimensional pose of the target;
based on at least two of the two-dimensional images, use the second three-dimensional pose estimation module to estimate a second three-dimensional pose of the target, wherein the at least two of the two-dimensional images have different viewing angles from each other; and
train, based on a difference between the first three-dimensional pose and the second three-dimensional pose, at least one of the first three-dimensional pose estimation module or the second three-dimensional pose estimation module.

2. The training apparatus according to claim 1, wherein the target comprises a plurality of feature points, and based on at least two of the two-dimensional images, using the second three-dimensional pose estimation module to estimate the second three-dimensional pose of the target comprises:
estimating, based on the at least two of the two-dimensional images, information of a three-dimensional space range in which each of the plurality of feature points of the target is located; and
estimating the second three-dimensional pose according to the information of the three-dimensional space range.

3. The training apparatus according to claim 2, wherein estimating, based on the at least two of the two-dimensional images, information of the three-dimensional space range in which each of the plurality of feature points of the target is located comprises:
estimating a two-dimensional feature point heat map of each of the at least two-dimensional images; and
estimating the information of the three-dimensional space range according to the two-dimensional feature point heat map.

4. The training apparatus according to claim 2, wherein estimating the second three-dimensional pose according to the information of the three-dimensional space range comprises:
estimating a three-dimensional feature point heat map according to the information of the three-dimensional space range; and
estimating the second three-dimensional pose according to the three-dimensional feature point heat map.

5. The training apparatus according to claim 4, wherein estimating the second three-dimensional pose according to the three-dimensional feature point heat map comprises:
estimating the second three-dimensional pose by performing soft-argmax processing on the three-dimensional feature point heat map.

6. The training apparatus according to claim 2, wherein the three-dimensional space range comprises a cubic space range.

7. The training apparatus according to claim 2, wherein estimating, based on the at least two of the two-dimensional images, information of the three-dimensional space range in which each of the plurality of feature points of the target is located comprises:
using a 3D pictorial structures (3DPS) module to estimate the information of the three-dimensional space range.

8. The training apparatus according to claim 1, wherein training, based on the difference between the first three-dimensional pose and the second three-dimensional pose, at least one of the first three-dimensional pose estimation module or the second three-dimensional pose estimation module comprises:
acquiring a first key point of the first three-dimensional pose and a second key point of the second three-dimensional pose;
correcting, based on the first key point and the second key point, the second three-dimensional pose and the first three-dimensional pose to a same viewing angle; and
training, based on a difference between the corrected first three-dimensional pose and second three-dimensional pose, at least one of the first three-dimensional pose estimation module or the second three-dimensional pose estimation module.

9. The training apparatus according to claim 8, wherein correcting, based on the first key point and the second key point, the second three-dimensional pose and the first three-dimensional pose to the same viewing angle comprises:
correcting the second three-dimensional pose to a viewing angle of the first three-dimensional pose to generate a third three-dimensional pose, such that at least one of the first three-dimensional pose estimation module or the second three-dimensional pose estimation module is trained based on a difference between the third three-dimensional pose and the first three-dimensional pose, and/or
wherein acquiring the first key point of the first three-dimensional pose and the second key point of the second three-dimensional pose comprises:
using a first lifting network module to estimate the first key point and the second key point, and/or
wherein the first key point is at a center position of the first three-dimensional pose, and the second key point is at a center position of the second three-dimensional pose.

10-11. (canceled)

12. The training apparatus according to claim 1, wherein based on any one of the two-dimensional images, using the first three-dimensional pose estimation module to estimate the first three-dimensional pose of the target comprises:
based on any one of the two-dimensional images, using a first two-dimensional detection module to estimate a two-dimensional pose of the target; and
according to the two-dimensional pose of the target, using a second lifting network module to estimate the first three-dimensional pose.

13. The training apparatus according to claim 12, wherein based on any one of the first two-dimensional images, using the first two-dimensional detection module to estimate the two-dimensional pose of the target comprises:
estimating, based on any one of the first two-dimensional images, a two-dimensional feature point heat map of the first two-dimensional image; and
estimating the two-dimensional pose according to the two-dimensional feature point heat map.

14. The training apparatus according to claim 13, wherein estimating the two-dimensional pose according to the two-dimensional feature point heat map comprises:
estimating the two-dimensional pose by performing soft-argmax processing on the two-dimensional feature point heat map.

15. The training apparatus according to claim 12, wherein the second lifting network module comprises a batch normalization layer, a dropout layer, a rectified linear layer, and a residual connection layer.

16. The training apparatus according to claim 1, wherein training, based on the difference between the first three-dimensional pose and the second three-dimensional pose, at least one of the first three-dimensional pose estimation module or the second three-dimensional pose estimation module comprises:
determining a mean square error (MSE) loss and a two-dimensional reprojection loss based on the difference between the first three-dimensional pose and the second three-dimensional pose; and
training, according to a weighted average of the MSE loss and the two-dimensional reprojection loss, at least one of the first three-dimensional pose estimation module or the second three-dimensional pose estimation module until a training end condition is met, and/or
wherein the target comprises a human target, and the plurality of feature points of the human target comprises a plurality of joint points, and/or
wherein the training apparatus further comprises:
a display device configured to display at least one of the first three-dimensional pose or the second three-dimensional pose, and/or
wherein the at least two of the two-dimensional images are acquired based on viewing angles and projection matrixes of a plurality of synchronous shooting devices.

17-19. (canceled)

20. An estimation apparatus for a three-dimensional pose, comprising:
the training apparatus for a machine learning model according to claim 1, which is configured to train a first three-dimensional pose estimation module of a machine learning model; and
at least one processor configured to:
acquire a two-dimensional image containing a target; and
based on the two-dimensional image, use the trained first three-dimensional pose estimation module to estimate a three-dimensional pose of the target.

21. The estimation apparatus according to claim 20, wherein the processor is configured to:
acquire a usage requirement of the machine learning model; and
convert the machine learning model to a format matched with the usage requirement, and/or
wherein the processor is configured to:
in response to a setting operation of a user, set a deployment environment and model parameters of the machine learning model.

22-23. (canceled)

24. A training method for a machine learning model, comprising:
based on any two-dimensional image containing a target, using a first three-dimensional pose estimation module of a machine learning model to estimate a first three-dimensional pose of the target;
based on at least two two-dimensional images containing the target, using a second three-dimensional pose estimation module of a machine learning model to estimate a second three-dimensional pose of the target, wherein the plurality of second two-dimensional images have different viewing angles from each other; and
training, based on a difference between the first three-dimensional pose and the second three-dimensional pose, at least one of the first three-dimensional pose estimation module or the second three-dimensional pose estimation module.

25. An estimation method for a three-dimensional pose, comprising:
training a first three-dimensional pose estimation module of a machine learning model in the training method for a machine learning model according to claim 24; and
based on a two-dimensional image containing a target, using the first three-dimensional pose estimation module to estimate a three-dimensional pose of the target.

26. An electronic device, comprising:
a memory; and
a processor coupled to the memory and configured to perform the training method for a machine learning model according to claim 24 based on instructions stored in the memory device.

27. A non-volatile computer-readable storage medium having a computer program stored thereon which, when executed by a processor, causes the training method for a machine learning model according to claim 24 to be implemented.
